(19) United States
(12) Patent Application Publication
(10) Pub. No.: US 2006/0028463 A1
(43) Pub. Date: Feb. 9, 2006

(54) Gate line driving circuit

(76) Inventors: Tetsuya Nakamura, Moriguchi-shi (JP); Seiji Kawaguchi, Hirakata-shi (JP); Masahiko Takeoka, Yamatokoriyama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/197,400

(22) Filed: Aug. 5, 2005

(30) Foreign Application Priority Data
Aug. 6, 2004 (JP) 2004-231105

(51) Int. Cl. G09G 5/00

(52) U.S. Cl. 345/204

(57) ABSTRACT

A gate line driving circuit includes a shift register for gradation display, which shifts a first start signal in response to a first clock signal such that the gate lines are selected for gradation display in one vertical scanning period, and a shift register for black insertion, which shifts a second start signal in response to a second clock signal synchronous with the first clock signal such that the gate lines are selected for black insertion in a period substantially equal to the vertical scanning period, and an output circuit that outputs, under control of a first output enable signal, a driving signal to the gate line selected by the shift register for gradation display, and outputs, under control of a second output enable signal, a driving signal to the gate line selected by the shift register for black insertion.

### CROSS-REFERENCE TO RELATED APPLICATIONS

This application is based upon and claims the benefit of priority from prior Japanese Patent Application No. 2004-231105, filed Aug. 6, 2004, the entire contents of which are incorporated herein by reference.

### BACKGROUND OF THE INVENTION

1. Field of the Invention

The present invention relates to a gate line driving circuit that is applied to an OCB (Optically Compensated Birefringence) mode liquid crystal display panel.

2. Description of the Related Art

Flat-panel display devices, which are typified by liquid crystal display devices, have widely been used as display devices for computers, car navigation systems, TV receivers, etc.

The liquid crystal display device generally includes a liquid crystal display panel including a matrix array of liquid crystal pixels, and a display panel control circuit that controls the display panel. The liquid crystal display panel is configured such that a liquid crystal layer is held between an array substrate and a counter substrate.

The array substrate includes a plurality of pixel electrodes that are arrayed substantially in a matrix, a plurality of gate lines that are arranged along rows of the pixel electrodes, a plurality of source lines that are arranged along columns of the pixel electrodes, and a plurality of switching elements that are arranged near intersections between the gate lines and the source lines. Each of the switching elements is formed of, e.g. a thin-film transistor (TFT), and turned on to apply a potential of one source line to one pixel electrode when one gate line is driven. On the counter substrate, a common electrode is provided to face the pixel electrodes arrayed on the array substrate. Each pair of pixel electrode and common electrode is associated with a pixel area of the liquid crystal layer to form a pixel, and controls the alignment state of liquid crystal molecules in the pixel area by an electric field obtained between the electrodes. The display panel control circuit includes a gate driver that drives the gate lines, a source driver that drives the source lines, and a controller that controls operational timings of the gate driver and source driver.

In the case where the liquid crystal display device is used for a TV receiver that principally displays a moving image, a liquid crystal display panel of an OCB mode, in which liquid crystal molecules exhibit good responsivity, is generally employed (see Jpn. Pat. Appln. KOKAI Publication No. 2002-202491). In the liquid crystal display panel, the liquid crystal molecules are aligned in a splay alignment before supply of power. This splay alignment is a state where the liquid crystal molecules are laid down, and obtained by alignment films which are disposed on the pixel electrode and the counter electrode and rubbed in parallel with each other. The liquid crystal display panel performs an initializing process upon supply of power. In this process, a relatively strong electric field is applied to the liquid crystal molecules to transfer the splay alignment to a bend alignment. A display operation is performed after the initializing process.

The reason why the liquid crystal molecules are aligned in the splay alignment before supply of power is that the splay alignment is more stable than the bend alignment in terms of energy in a state where the liquid crystal driving voltage is not applied. As a characteristic of the liquid crystal molecules, the bend alignment tends to be inverse-transferred to the splay alignment if a state where no voltage is applied or a state where a voltage lower than a level at which the energy of splay alignment is balanced with the energy of bend alignment is applied, continues for a long time. The viewing angle characteristic of the splay alignment significantly differs from that of the bend alignment. Thus, a normal display is not attained in this splay alignment.

In a conventional driving method that prevents the inverse transfer from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving.” In the meantime, in the black insertion driving, the visibility, which lowers due to retinal persistence occurring on a viewer's vision in a moving image display, is improved by discrete pseudo-impulse response of luminance.

A pixel voltage for black insertion and a pixel voltage for gradation display are applied to all liquid crystal pixels on a row-by-row basis in one frame period, i.e. one vertical scanning period (V). The ratio of a storage period of the pixel voltage for black insertion to a storage period of the pixel voltage for gradation display is a black insertion ratio. In a case where each gate line is driven for black insertion in a half of one horizontal scanning period, i.e. H/2 period, and is driven for gradation display in a subsequent H/2 period, the vertical scanning speed becomes twice higher than in the case where black insertion is not executed. Since the value of the pixel voltage for black insertion is common to all pixels, it is possible to drive, for instance, two gate lines together as a set. In a case where two gate lines of each set are driven together for black insertion in a 2H/3 period, and are sequentially driven for gradation display in a 4H/3 period (2H/3 for each of two gate lines), the vertical scanning speed becomes 1.5 times higher than in the case where black insertion is not executed.

The conventional black insertion driving is executed using a gate driver that includes, as a gate line driving circuit, a shift register that shifts a start signal in response to a clock signal, and an output circuit that outputs driving signals to gate lines, which are selected for black insertion and gradation display by the start signal that is stored in the shift register. In this output circuit, the output of driving signals for three neighboring gate lines is controlled by three independent output enable signals.

The gate line driving circuit is required to have vertical scanning speeds that vary depending on panel sizes, as shown in FIG. 10. In addition, the vertical scanning speed has to be attained while the increment of the black insertion ratio is kept at a practical value in relation to the number of horizontal scanning periods (H) in one vertical scanning period (V). In general, a video signal includes, in addition to image data, a back porch (BP) that is composed of a plurality of horizontal sync pulses that are arranged at intervals of 1H for vertical sync. Normally, the gate driver attains vertical scanning speeds such as 1.25×, 1.5× and 2× by making use of a part of all horizontal scanning periods (H) of the back porch.

With the structure of the above-described gate line driving circuit, however, it is not possible to execute black insertion driving at a vertical scanning speed of 1.25×, which is required for a large-sized WXGA display panel of, e.g. 15.1 to 32 inches. In addition, in the above-described gate line driving circuit, a number of Hs, which is an odd multiple of 6 or an odd multiple of 3, is needed in 1V in a case where black insertion driving is executed at a vertical scanning speed of 1.5× or 2×, which is required for a medium-sized WXGA display panel of, e.g. 7 to 9 inches. However, the total number of Hs of the back porch is set to be smaller as the panel size decreases, and it is difficult to secure a number of Hs that is an odd multiple of 6 or an odd multiple of 3 for the medium-sized WVGA display panel. It is very difficult to secure this number of Hs for a small-sized VGA display panel of 2.2 inches. Furthermore, the increment of the black insertion ratio, i.e. the interval of Hs for black insertion, relative to the number of Hs in 1V, becomes impracticable if it exceeds 2%.

### BRIEF SUMMARY OF THE INVENTION

An object of the present invention is to provide a gate line driving circuit that is capable of obtaining various vertical scanning speeds that are required in black insertion driving.

According to a first aspect of the present invention, there is provided a gate line driving circuit that drives a plurality of gate lines assigned to a plurality of pixels on a display panel, comprising: a first shift register which shifts a first start signal in response to a first clock signal such that the gate lines are selected for gradation display in one vertical scanning period; a second shift register which shifts a second start signal in response to a second clock signal synchronous with the first clock signal such that the gate lines are selected for non-gradation display in a period substantially equal to the vertical scanning period; and an output circuit that outputs, under control of a first output enable signal, a driving signal to the gate line that is selected by the first shift register, and outputs, under control of a second output enable signal, a driving signal to the gate line that is selected by the second shift register.

According to a second aspect of the present invention, there is provided a gate line driving circuit that drives a plurality of gate lines, comprising: a first shift register which shifts a first start signal in response to a first clock signal such that the gate lines are sequentially selected for gradation display; a second shift register which shifts a second start signal in response to a second clock signal synchronous with the first clock signal such that the gate lines are sequentially selected for non-gradation display, in units of at least two lines; and an output circuit that outputs, under control of a first output enable signal, a driving signal to the gate line that is selected by the first shift register, and outputs, under control of a second output enable signal, a driving signal to the gate line that is selected by the second shift register.

In this gate line driving circuit, the first and second shift registers are independently provided for gradation display and for non-gradation display. The output circuit outputs, under the control of the first output enable signal, the driving signal to the gate line that is selected by the first shift register. The output circuit outputs, under the control of the second output enable signal, the driving signal to the gate line that is selected the second shift register. By virtue of this structure, the first and second start signals, the first and second clock signals, and the first and second output enable signals may be combined to simultaneously drive a predetermined number of gate lines for non-gradation display and to sequentially drive the predetermined number of gate lines for gradation display. For example, if the operation of driving one gate line in a 1H (horizontal scanning period)/2 period for non-gradation display and driving the gate line in a 1H/2 period for gradation display is repeated, a 2× vertical scanning speed can be obtained. If the operation of driving two gate lines together in a 2H/3 period for non-gradation display and driving the two gate lines sequentially in a 4H/3 period (2H/3 for each gate line) for gradation display is repeated, a 1.5× vertical scanning speed can be obtained. If the operation of driving four gate lines together in a 4H/5 period for non-gradation display and driving the four gate lines sequentially in a 16H/5 period (4H/5 for each gate line) for gradation display is repeated, a 1.25× vertical scanning speed can be obtained. The gate line driving circuit can thus obtain various vertical scanning speeds required for black insertion driving in which black insertion is carried out as the non-gradation display.

When the vertical scanning speed is 1.5× or 2×, which is required for middle-sized or small-sized display panels, a number of Hs, which corresponds to an odd multiple of 2, and a number of Hs, which corresponds to an odd multiple of 1, are required in 1V (vertical scanning period) respectively. These numbers of Hs can easily be secured for the middle-sized or small-sized display panels. Besides, when the vertical scanning speed is 1.25×, which is required for large-sized display panels, a number of Hs, which corresponds to an odd multiple of 4, is required in 1V. This number of Hs, too, can easily be secured for the large-sized display panels. Therefore, the increment of the black insertion ratio can be reduced to a practical value in accordance with various panel sizes.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the circuit configuration of a liquid crystal display device according to an embodiment of the present invention;

FIG. 2 shows in detail a gate line driving circuit of a gate driver shown in FIG. 1;

FIG. 3 is a time chart that explains the operation of the gate line driving circuit shown in FIG. 2 in a case where black insertion driving is executed at a 2× (double) vertical scanning speed;

FIG. 4 is a time chart that explains the operation of the gate line driving circuit shown in FIG. 2 in a case where black insertion driving is executed at a 1.5× vertical scanning speed;

FIG. 5 is a time chart that explains the operation of the gate line driving circuit shown in FIG. 2 in a case where black insertion driving is executed at a 1.25× vertical scanning speed;

FIG. 6 shows a modification of the gate line driving circuit shown in FIG. 2;

FIG. 7 is a time chart that explains the operation of a gate line driving circuit according to a comparative example in a case where black insertion driving is executed at a 2× vertical scanning speed;

FIG. 8 is a time chart that explains the operation of the gate line driving circuit according to the comparative example in a case where black insertion driving is executed at a 1.5× vertical scanning speed;

FIG. 9 shows features that are obtained when the gate line driving circuit shown in FIG. 2 is applied to display panels of various sizes; and

FIG. 10 shows features that are obtained when a conventional gate line driving circuit is applied to display panels of various sizes.

### DETAILED DESCRIPTION OF THE INVENTION

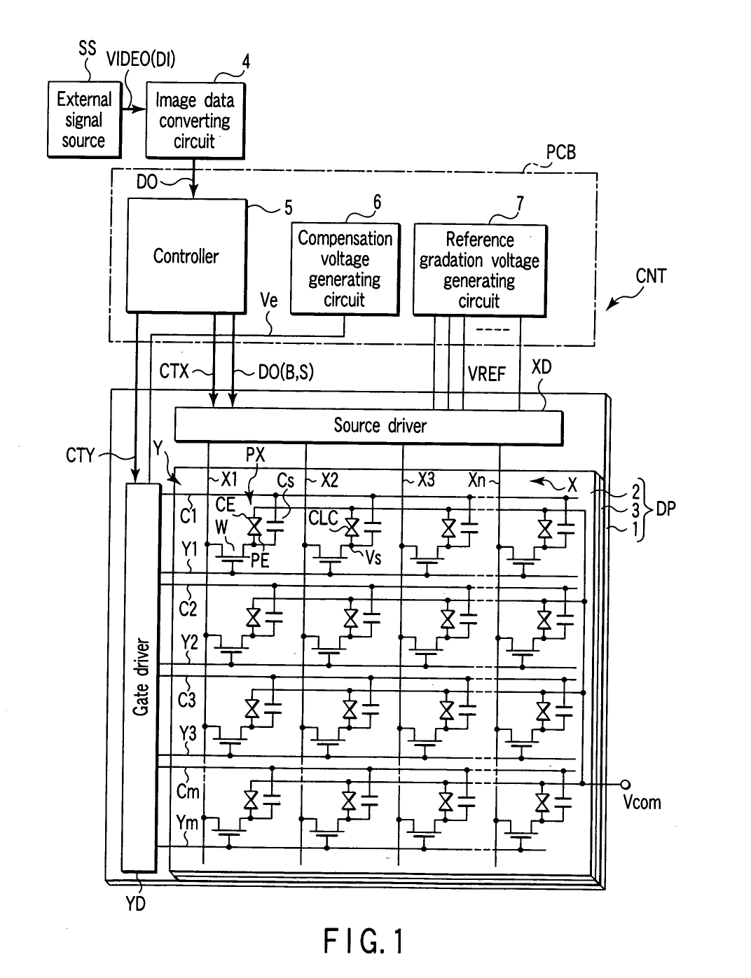

A liquid crystal display device according to an embodiment of the present invention will now be described with reference to the accompanying drawings. FIG. 1 schematically shows the circuit configuration of the liquid crystal display device. The liquid crystal display device comprises a liquid crystal display panel DP and a display panel control circuit CNT that is connected to the display panel DP. The liquid crystal display panel DP is configured such that a liquid crystal layer 3 is held between an array substrate 1 and a counter substrate 2, which are a pair of electrode substrates. The liquid crystal layer 3 contains a liquid crystal material whose liquid crystal molecules are transferred in advance from a splay alignment to a bend alignment usable for a normally-white display, and are prevented from being inverse-transferred from the bend alignment to the splay alignment by a voltage for black insertion (non-gradation display) that is cyclically applied. The display panel control circuit CNT controls the transmittance of the liquid crystal display panel DP by a liquid crystal driving voltage that is applied from the array substrate 1 and counter electrode 2 to the liquid crystal layer 3. The display panel control circuit CNT performs a predetermined initializing process upon supply of power. The splay alignment is transferred to the bend alignment by a relatively strong electric field applied to the liquid crystal layer 3 in the initializing process.

The array substrate 1 includes a plurality of pixel electrodes PE that are arrayed substantially in a matrix on a transparent insulating substrate of, e.g. glass; a plurality of gate lines Y (Y1 to Ym) that are disposed along rows of the pixel electrodes PE; a plurality of storage capacitance lines C (C1 to Cm) that are disposed in parallel to the gate lines Y (Y1 to Ym) along the rows of the pixel electrodes PE; a plurality of source lines X (X1 to Xn) that are disposed along columns of the pixel electrodes PE; and a plurality of pixel switching elements W that are disposed near intersections between the gate lines Y and source lines X, each pixel switching element W being rendered conductive between the associated source line X and associated pixel electrode PE when driven via the associated gate line Y. Each of the pixel switching elements W is composed of, e.g. a thin-film transistor. The thin-film transistor has a gate connected to the associated gate line Y, and a source-drain path connected between the associated source line X and pixel electrode PE.

The counter substrate 2 includes a color filter that is disposed on a transparent insulating substrate of, e.g. glass, and a common electrode CE that is disposed on the color filter so as to be opposed to the pixel electrodes PE. Each pixel electrode PE and the common electrode CE are formed of a transparent electrode material such as ITO, and are coated with alignment films that are subjected to rubbing treatment in directions parallel to each other. To form an OCB liquid crystal pixel PX, each pixel electrode PE and the common electrode CE are associated with a pixel area of the liquid crystal layer 3 which is controlled to have a liquid crystal alignment corresponding to an electric field applied from the pixel electrode PE and common electrode CE.

Each of OCB liquid crystal pixels PX has a liquid crystal capacitance CLC between the associated pixel electrode PE and the common electrode CE. Each of the storage capacitance lines C1 to Cm constitutes storage capacitances Cs by capacitive-coupling to the pixel electrodes PE of the liquid crystal pixels on the associated row. The storage capacitance Cs has a sufficiently large capacitance value, relative to a parasitic capacitance of the pixel switching element W.

The display panel control circuit CNT includes a gate driver YD that drives the gate lines Y1 to Ym so as to turn on the switching elements W on a row-by-row basis; a source driver XD that outputs pixel voltages Vs to the source lines X1 to Xn in a time period in which the switching elements W on each row are driven by the associated gate line Y; an image data converting circuit 4 that executes, e.g. double-speed (2×) black inserting conversion for image data included in a video signal VIDEO that is input from an external signal source SS; and a controller 5 that controls, e.g. operation timings of the gate driver YD and source driver XD in association with the conversion result. The pixel voltage Vs is a voltage that is applied to the pixel electrode PE with reference to a common voltage Vcom of the common electrode CE. The polarity of the pixel voltage Vs is reversed, relative to the common voltage Vcom, so as to execute, e.g. line-reversal driving and frame-reversal driving (1H1V reversal driving). The image data is composed of pixel data relating to all liquid crystal pixels PX, and is updated in units of one frame period (vertical scanning period V). In the double-speed black inserting conversion, input pixel data DI for one row are converted in every 1H period to pixel data B for black insertion for one row and pixel data S for gradation display for one row, which become output pixel data DO. The pixel data S for gradation display has the same gradation value as the pixel data DI, and the pixel data B for black insertion has a gradation value for black display. Each of the pixel data B for black insertion for one row and the pixel data S for gradation display for one row is serially output from the image data converting circuit 4 in every H/2 period.

The gate driver YD and source driver XD are constructed using thin-film transistors that are formed in the same fabrication steps as, e.g. the switching elements W. On the other hand, the controller 5 is disposed on an outside printed circuit board PCB. The image data converting circuit 4 is disposed further on the outside of the printed circuit board PCB. The controller 5 generates a control signal CTY for selectively driving the gate lines Y, and a control signal CTX that assigns the pixel data for black insertion or gradation display, which are serially output as a conversion result of the image data converting circuit 4, to the source lines X, and designates the signal polarity. The control signal CTY is supplied from the controller 5 to the gate driver YD. The control signal CTX is supplied from the controller 5 to the source driver XD, together with the pixel data DO that is the pixel data B for black insertion or the pixel data S for gradation display, which is obtained as a conversion result of the image data converting circuit 4.

The display panel control circuit CNT further includes a compensation voltage generating circuit 6 and a reference gradation voltage generating circuit 7. The compensation voltage generating circuit 6 generates a compensation voltage Ve that is applied via the gate driver YD to the storage capacitance line C of the row corresponding to switching elements W on one row when the switching elements W on this row are turned off, and that compensates a variation in the pixel voltage Vs, which occurs in the pixels PX on the associated row due to parasitic capacitances of these switching elements W. The reference gradation voltage generating circuit 7 generates a predetermined number of reference gradation voltages VREF that are used in order to convert the pixel data DO to the pixel voltage Vs.

Under the control of the control signal CTY, the gate driver YD selects the gate line, Y1 to Ym, for black insertion in every vertical scanning period, and delivers to the selected gate line Y a driving signal so as to turn on the pixel switching elements W on each row in every H/2 period. Further, the gate driver YD selects the gate line, Y1 to Ym, for gradation display in every vertical scanning period, and delivers to the selected gate line Y a driving signal so as to turn on the pixel switching elements W on each row in every H/2 period. The image data converting circuit 4 alternately outputs the pixel data B for black insertion for one row and the pixel data S for gradation display for one row, which are obtained as the output pixel data DO that are the result of conversion. The source driver XD refers to the predetermined number of reference gradation voltages VREF, which are delivered from the reference gradation voltage generating circuit 7, and converts the pixel data B for black insertion and the pixel data S for gradation display to the pixel voltages Vs and outputs the pixel voltages Vs to the source lines X1 to Xn in parallel.

Assume now that the gate driver YD drives the gate line Y1, for instance, by the driving voltage, and turns on all pixel switching elements W that are connected to the gate line Y1. In this case, the pixel voltages on the source lines X1 to Xn are applied via the pixel switching elements W to the associated pixel electrodes PE and to terminals at one end of the associated storage capacitances Cs. In addition, the gate driver YD outputs the compensation voltage Ve from the compensation voltage generating circuit 6 to the storage capacitance line C1 that corresponds to the other terminals of the associated storage capacitances Cs. Immediately after turning on all pixel switching elements W, which are connected to the gate line Y1, for an H/2 period, the gate driver YD outputs to the gate line Y1 a non-driving voltage that turns off the pixel switching elements W. When the pixel switching elements W are turned off, the compensation voltage Ve reduces the amount of charge that leaks from the pixel electrodes PE to charge the parasitic capacitances of the pixel switching elements W, thereby substantially canceling a variation in pixel voltage Vs, that is, a field-through voltage ΔVp.

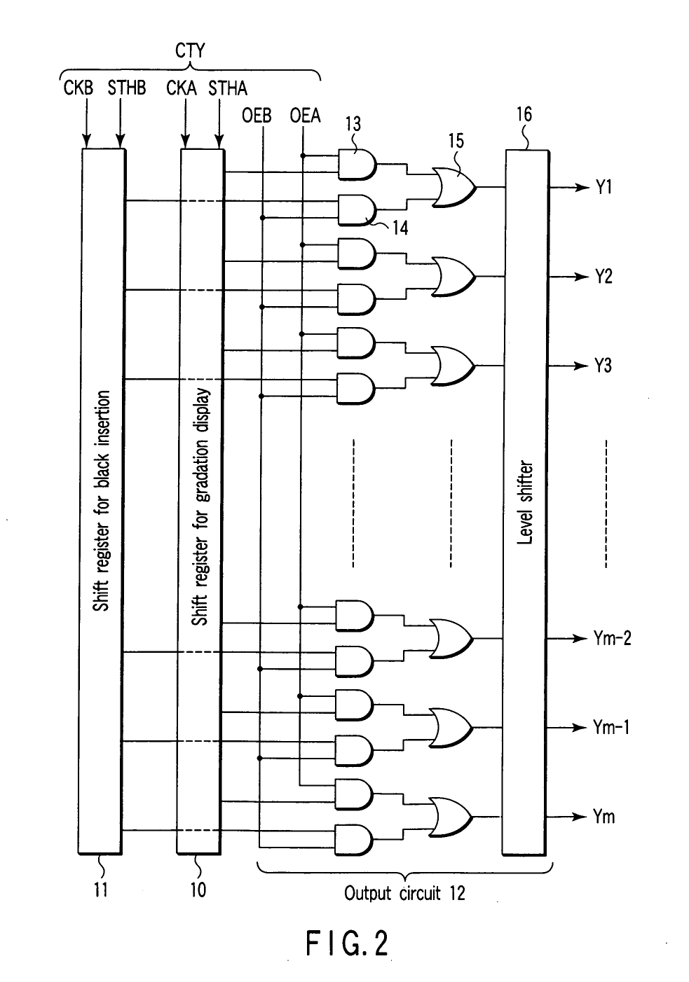

FIG. 2 shows in detail the gate line driving circuit of the gate driver YD. The gate line driving circuit includes a shift register 10 for gradation display (a first shift register), which shifts a first start signal STHA in response to a first clock signal CKA; a shift register 11 for black insertion (a second shift register), which shifts a second start signal STHB in response to a second clock signal CKB synchronous with the first clock signal CKA; and an output circuit 12 that outputs a driving signal, under control of a first output enable signal OEA, to the gate line Y that is selected in accordance with the shift position of the first start signal STHA stored in the shift register 10 for gradation display, and also outputs a driving signal, under control of a second output enable signal OEB, to the gate line Y that is selected in accordance with the shift position of the second start signal STHB stored in the shift register 11 for black insertion. The first clock signal CKA, first start signal STHA, second clock signal CKB, second start signal STHB, first output enable signal OEA and second output enable signal OEB are all included in the control signal CTY that is supplied from the controller 5.

Each of the shift register 10 for gradation display and the shift register 11 for black insertion comprises series-connected m-stages of registers that are assigned to the gate lines Y1 to Ym. The first start signal STHA and second start signal STHB are input to the first-stage registers that are assigned to the gate line Y1. In the shift register 10 for gradation display, the first start signal STHA is shifted from the first-stage register toward the m-th stage register. In the shift register 11 for black insertion, the second start signal STHB is shifted from the first-stage register toward the m-th stage register. Each of all registers in the shift register 10 for gradation display has an output terminal that outputs a selection signal for the associated gate line Y, which rises to a high level while the first start signal STHA is being retained. Each of all registers in the shift register 11 for black insertion has an output terminal that outputs a selection signal for the associated gate line Y, which rises to a high level while the second start signal STHB is being retained.

The output circuit 12 includes an m-number of AND gate circuits 13, an m-number of AND gate circuits 14, an m-number of OR gate circuits 15 and a level shifter 16. The m-number of AND gate circuits 13 are so connected as to output the selection signals for the gate lines Y1 to Ym, which are obtained from the shift register 10 for gradation display, to the m-number of OR gate circuits 15 under the control of the first output enable signal OEA. The first output enable signal OEA permits all the AND gate circuits 13 to output the selection signals in the state in which the first output enable signal OEA is set at a high level, and the first output enable signal OEA prohibits all the AND gate circuits 13 from outputting the selection signals in the state in which the first output enable signal OEA is set at a low level. The m-number of AND gate circuits 14 are so connected as to output the selection signals for the gate lines Y1 to Ym, which are obtained from the shift register 11 for black insertion, to the m-number of OR gate circuits 15 under the control of the second output enable signal OEB. The second output enable signal OEB permits all the AND gate circuits 14 to output the selection signals in the state in which the second output enable signal OEB is set at a high level, and the second output enable signal OEB prohibits all the AND gate circuits 14 from outputting the selection signals in the state in which the second output enable signal OEB is set at a low level. The m-number of OR gate circuits 15 input the selection signals from the associated AND gate circuits 13 and the selection signals from the associated AND gate circuits 14 to the level shifter 16. The level shifter 16 is configured to shift the level of the voltages of the selection signals that are input from the m-number of OR gate circuits 15, thereby converting the voltages to driving signals for turning on the thin-film transistors W, and delivering the driving signals to the gate lines Y1 to Ym.

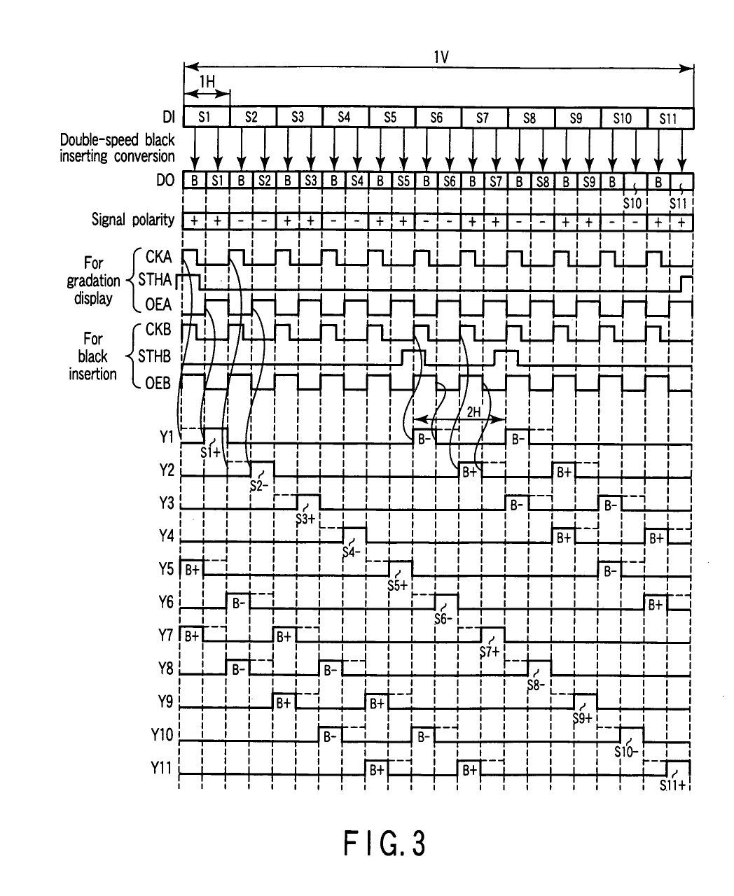

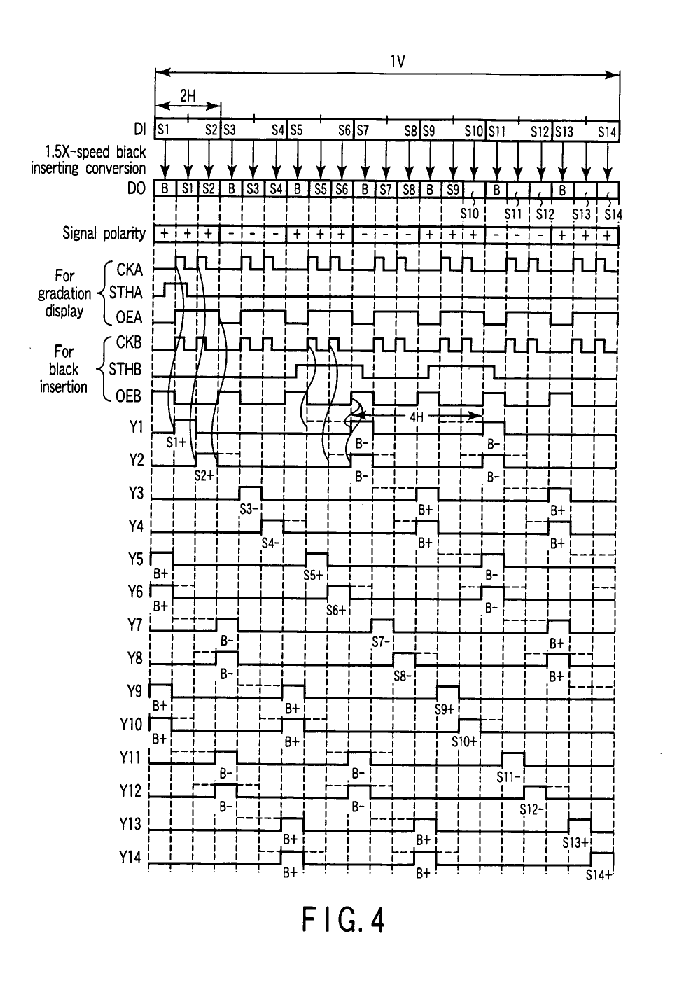

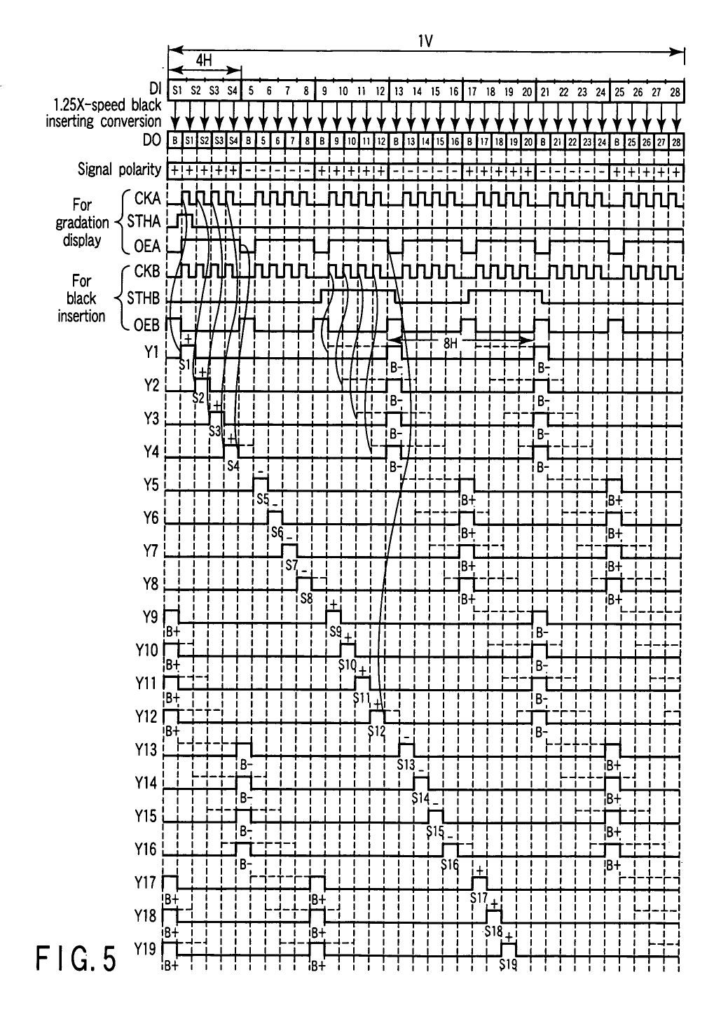

The operation of the gate line driving circuit shown in FIG. 2 is described referring to FIG. 3, FIG. 4 and FIG. 5. In FIGS. 3 to 5, symbol B represents pixel data for black insertion, which is common to the pixels PX of the respective rows, and S1, S2, S3, . . . , designate pixel data for gradation display, which are associated with pixels PX on the first row, pixels PX on the second row, pixels PX on the third row, etc. Symbols + and − represent signal polarities at a time when the pixel data B, S1, S2, S3, . . . , are converted to pixel voltages Vs and output from the source driver XD.

FIG. 3 illustrates the operation of the gate line driving circuit in a case where black insertion driving is executed at a double (2×) vertical scanning speed. The first start signal STHA is a pulse that is input to the shift register 10 for gradation display with a pulse width corresponding to an H/2 period. The first clock signal CKA is a 1H-cycle pulse that is input to the shift register 10 for gradation display at a rate of 1 pulse per 1H period. The shift register 10 for gradation display shifts the first start signal STHA in response to the first clock signal CKA, and outputs the selection signals to sequentially select the gate lines Y1 to Ym in a manner that each gate line remains selected for 1H period. The m-number of AND gate circuits 13 output, under the control of the first output enable signal OEA, the selection signals, which are sequentially obtained from the shift register 10 for gradation display, to the m-number of OR gate circuits 15 in the latter half of every 1H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for gradation display, S1, S2, S3, . . . , to the pixel voltages Vs in the latter half of the associated horizontal scanning period H, and outputs the pixel voltages Vs in parallel to the source lines X1 to Xn with the polarity that is reversed in every 1H period. The pixel voltages Vs are applied to the liquid crystal pixels PX on the first row, second row, third row, . . . , while each of the gate lines Y1 to Ym is driven in the latter half of the associated horizontal scanning period H.

On the other hand, the second start signal STHB is a pulse that is input to the shift register 11 for black insertion with a pulse width corresponding to an H/2 period. The second clock signal CKB is a 1H-cycle pulse that is input to the shift register 11 for black insertion at a rate of 1 pulse per 1H period in sync with the first clock signal CKA. The shift register 11 for black insertion shifts the second start signal STHB in response to the second clock signal CKB, and outputs the selection signals to sequentially select the gate lines Y1 to Ym on a line-by-line basis. The m-number of AND gate circuits 14 output, under the control of the second output enable signal OEB, the selection signals, which are sequentially obtained from the shift register 11 for black insertion, to the m-number of OR gate circuits 15 in the first half of every 1H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for black insertion, B, B, B, . . . , to the pixel voltages Vs in the first half of the associated horizontal scanning period H, and outputs the pixel voltages Vs in parallel to the source lines X1 to Xn with the polarity that is reversed in every 1H period. The pixel voltages Vs are applied to the liquid crystal pixels PX on the first row, second row, third row, . . . , while each of the gate lines Y1 to Ym is driven in the first half of the associated horizontal scanning period H. In FIG. 3, the first start signal STHA and second start signal STHB are input with a relatively short interval. Actually, the first start signal STHA and second start signal STHB are input with a relatively long interval so that the ratio of a voltage storage period for black insertion to a voltage storage period for gradation display may accord with a desired black insertion ratio. In addition, it is preferable to input the second start signal STHB once again with a delay of 2H after the first input of the second start signal STHB. Thereby, each gate line Y is driven twice for black insertion. Accordingly, even in the case where it is difficult to shift the potential of the associated pixel electrode PE up to a high pixel voltage Vs for black insertion within a short period of H/2, the pixel voltage Vs can surely be set in the pixel electrode PE. The above-mentioned 2H delay is needed in order to uniformize the polarity of the pixel voltages Vs for black insertion. In the meantime, black insertion for the pixels PX near the last row is continuous from the preceding frame, for example, as shown in the lower left part of FIG. 3.

In the case where black insertion driving is performed at a 1.5× vertical scanning speed, the image data converting circuit 4 is configured to execute 1.5×-speed black inserting conversion for image data that is included in the video signal VIDEO, which is input from the external signal source SS. In addition, the source driver XD is configured to output to the source lines X1 to Xn the pixel voltages Vs whose polarity is reversed, relative to the common voltage Vcom, so as to execute 2-line-unit reversal driving and frame-reversal driving (2H1V reversal driving). In the 1.5×-speed black inserting conversion, input pixel data DI for two rows is converted to pixel data B for black insertion for one row and pixel data S for gradation display for two rows, which become output pixel data DO, in every 2H period. The pixel data S for gradation display has the same gradation value as the pixel data DI, and the pixel data B for black insertion has the gradation value for black insertion. Each of the pixel data B for black insertion for one row and pixel data S for gradation display for two rows is serially output from the image data converting circuit 4 in every 2H/3 period.

FIG. 4 illustrates the operation of the gate line driving circuit in a case where black insertion driving is executed at a 1.5× vertical scanning speed. The first start signal STHA is a pulse that is input to the shift register 10 for gradation display with a pulse width corresponding to a 2H/3 period. The first clock signal CKA is a 2H/3-cycle pulse that is input to the shift register 10 for gradation display at a rate of 2 pulses per 2H period. The shift register 10 for gradation display shifts the first start signal STHA in response to the first clock signal CKA, and outputs the selection signals to sequentially select the gate lines Y1 to Ym in a manner that each gate line remains selected for a 2H/3 period. In this scheme, the pulse of the first clock signal CKA is omitted in the first 2H/3 period in the 2H period. Thus, the selection signal for an even-numbered gate line Y2, Y4, Y6, is continuously output until the end of the first 2H/3 period in the subsequent 2H period. On the other hand, the m-number of AND gate circuits 13 output, under the control of the first output enable signal OEA, the selection signals, which are sequentially obtained from the shift register 10 for gradation display, to the m-number of OR gate circuits 15 in the second and third 2H/3 periods in the associated 2H period. Each selection signal is supplied from the associated OR gate circuit 15 to the level shifter 16. The level shifter 16 converts the selection signal to a driving signal and outputs it to the associated gate line Y. Besides, the source driver XD converts each of the pixel data for gradation display, S1, S2, S3, . . . , to the pixel voltages Vs in the second and third 2H/3 periods in the associated 2H period, and outputs the pixel voltages Vs in parallel to the source lines X1 to Xn with the polarity that is reversed in every 2H period. The pixel voltages Vs are applied to the liquid crystal pixels PX on the first row, second row, third row, . . . , while each of the gate lines Y1 to Ym is driven in the second and third 2H/3 periods in the associated 2H period.

On the other hand, the second start signal STHB is a pulse that is input to the shift register 11 for black insertion with a pulse width corresponding to a 2H period. The second clock signal CKB is a 2H/3-cycle pulse that is input to the shift register 11 for black insertion at a rate of 2 pulses per 2H period in sync with the first clock signal CKA. The shift register 11 for black insertion shifts the second start signal STHB in response to the second clock signal CKB, and outputs the selection signals to sequentially select the gate lines Y1 to Ym in units of two lines. The m-number of AND gate circuits 14 output, under the control of the second output enable signal OEB, the selection signals, which are sequentially obtained from the shift register 11 for black insertion, to the m-number of OR gate circuits 15 in the first 2H/3 period in the subsequent 2H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for black insertion, B, B, B, . . . , to the pixel voltages Vs in the first 2H/3 period of the associated 2H period, and outputs the pixel voltages Vs in parallel to the source lines X1 to Xn with the polarity that is reversed in every 2H period. The pixel voltages Vs are applied to the liquid crystal pixels PX on the first & second rows, third & fourth rows, fifth & sixth rows, . . . , while each of the gate lines Y1 to Ym is driven in the first 2H/3 period in the associated 2H period. In FIG. 4, too, the first start signal STHA and second start signal STHB are input with a relatively short interval. Actually, the first start signal STHA and second start signal STHB are input with a relatively long interval so that the ratio of a voltage storage period for black insertion to a voltage storage period for gradation display may accord with a desired black insertion ratio. In addition, it is preferable to input the second start signal STHB once again with a delay of 4H after the first input of the second start signal STHB. Thereby, each gate line Y is driven twice for black insertion. Accordingly, even in the case where it is difficult to shift the potential of the associated pixel electrode PE up to a high pixel voltage Vs for black insertion within a short period of 2H/3, the pixel voltage Vs can surely be set in the pixel electrode PE. The above-mentioned 4H delay is needed in order to uniformize the polarity of the pixel voltages Vs for black insertion. In the meantime, black insertion for the pixels PX near the last row is continuous from the preceding frame, for example, as shown in the lower left part of FIG. 4.

In the case where black insertion driving is performed at a 1.25× vertical scanning speed, the image data converting circuit 4 is configured to execute 1.25×-speed black inserting conversion for image data that is included in the video signal VIDEO, which is input from the external signal source SS. In addition, the source driver XD is configured to output to the source lines X1 to Xn the pixel voltages Vs whose polarity is reversed, relative to the common voltage Vcom, so as to execute 4-line-unit reversal driving and frame-reversal driving (4H1V reversal driving). In the 1.25×-speed black inserting conversion, input pixel data DI for four rows is converted to pixel data B for black insertion for one row and pixel data S for gradation display for four rows, which become output pixel data DO, in every 4H period; The pixel data S for gradation display has the same gradation value as the pixel data DI, and the pixel data B for black insertion has the gradation value for black insertion. Each of the pixel data B for black insertion for one row and pixel data S for gradation display for four rows is serially output from the image data converting circuit 4 in every 4H/5 period.

FIG. 5 illustrates the operation of the gate line driving circuit in a case where black insertion driving is executed at a 1.25× vertical scanning speed. The first start signal STHA is a pulse that is input to the shift register 10 for gradation display with a pulse width corresponding to a 4H/5 period. The first clock signal CKA is a 4H/5-cycle pulse that is input to the shift register 10 for gradation display at a rate of 4 pulses per 4H period. The shift register 10 for gradation display shifts the first start signal STHA in response to the first clock signal CKA, and outputs the selection signals to sequentially select the gate lines Y1 to Ym in a manner that each gate line remains selected for a 4H/5 period. In this scheme, the pulse of the first clock signal CKA is omitted in the first 4H/5 period in the 4H period. Thus, the selection signal for the gate line Y4, Y8, Y12, . . . , is continuously output until the end of the first 4H/5 period in the subsequent 4H period. On the other hand, the m-number of AND gate circuits 13 output, under the control of the first output enable signal OEA, the selection signals, which are sequentially obtained from the shift register 10 for gradation display, to the m-number of OR gate circuits 15 in the second, third, fourth and fifth 4H/5 periods in the associated 4H period. Each selection signal is supplied from the associated OR gate circuit 15 to the level shifter 16. The level shifter 16 converts the selection signal to a driving signal and outputs it to the associated gate line Y. Besides, the source driver XD converts each of the pixel data for gradation display, S1, S2, S3, . . . , to the pixel voltages Vs in the second, third, fourth and fifth 4H/5 periods in the associated 4H period, and outputs the pixel voltages Vs in parallel to the source lines X1 to Xn with the polarity that is reversed in every 4H period. The pixel voltages Vs are applied to the liquid crystal pixels PX on the first row, second row, third row, fourth row, . . . , while each of the gate lines Y1 to Ym is driven in the second, third, fourth and fifth 4H/5 periods in the associated 4H period.

On the other hand, the second start signal STHB is a pulse that is input to the shift register 11 for black insertion with a pulse width corresponding to a 4H period. The second clock signal CKB is a 4H/5-cycle pulse that is input to the shift register 11 for black insertion at a rate of 4 pulses per 4H period in sync with the first clock signal CKA. The shift register 11 for black insertion shifts the second start signal STHB in response to the second clock signal CKB, and outputs the selection signals to sequentially selecting the gate lines Y1 to Ym in units of four lines. The m-number of AND gate circuits 14 output, under the control of the second output enable signal OEB, the selection signals, which are sequentially obtained from the shift register 11 for black insertion, to the m-number of OR gate circuits 15 in the first 4H/5 period in the subsequent 4H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for black insertion, B, B, B, . . . , to the pixel voltages Vs in the first 4H/5 period in the associated 4H period, and outputs the pixel voltages Vs in parallel to the source lines X1 to Xn with the polarity that is reversed in every 4H period. The pixel voltages Vs are applied to the liquid crystal pixels PX on the, second, third & fourth rows; fifth, sixth, seventh, and eighth rows; . . . , while each of the gate lines Y1 to Ym is driven in the first 4H/5 period in the associated 4H period. In FIG. 5, too, the first start signal STHA and second start signal STHB are input with a relatively short interval. Actually, the first start signal STHA and second start signal STHB are input with a relatively long interval so that the ratio of a voltage storage period for black insertion to a voltage storage period for gradation display may accord with a desired black insertion ratio. In addition, it is preferable to input the second start signal STHB once again with a delay of 8H after the first input of the second start signal STHB. Thereby, each gate line Y is driven twice for black insertion. Accordingly, even in the case where it is difficult to shift the potential of the associated pixel electrode PE up to a high pixel voltage Vs for black insertion within a short period of 4H/5, the pixel voltage Vs can surely be set in the pixel electrode PE. The above-mentioned 8H delay is needed in order to uniformize the polarity of the pixel voltages Vs for black insertion. In the meantime, black insertion for the pixels PX near the last row is continuous from the preceding frame, for example, as shown in the lower left part of FIG. 5.

In the present embodiment, the shift register 10 for gradation display and the shift register 11 for black insertion are independently provided. The output circuit 12 outputs, under the control of the first output enable signal OEA, the driving signal to the gate line Y that is selected in accordance with the shift position of the first start signal STHA. The output circuit 12 outputs, under the control of the second output enable signal OEB, the driving signal to the gate line Y that is selected in accordance with the shift position of the second start signal STHB. By virtue of this structure, the first and second start signals STHA and STHB, the first and second clock signals CKA and CKB, and the first and second output enable signals OEA and OEB may be combined to simultaneously drive a predetermined number of gate lines for black insertion and to sequentially drive a predetermined number of gate lines for gradation display. Thus, the gate line driving circuit can obtain various vertical scanning speeds that are needed for the black insertion driving.

When the vertical scanning speed is 1.5× or 2×, which is required for middle-sized or small-sized display panels, a number of Hs, which corresponds to an odd multiple of 2, and a number of Hs, which corresponds to an odd multiple of 1, are required in 1V (vertical scanning period) respectively. These numbers of Hs can easily be secured for the middle-sized or small-sized display panels. Besides, when the vertical scanning speed is 1.25×, which is required for large-sized display panels, a number of Hs, which corresponds to an odd multiple of 4 is required in 1V. This number of Hs, too, can easily be secured for the large-sized display panels. Therefore, the increment of the black insertion ratio can be reduced to a practical value in accordance with various panel sizes.

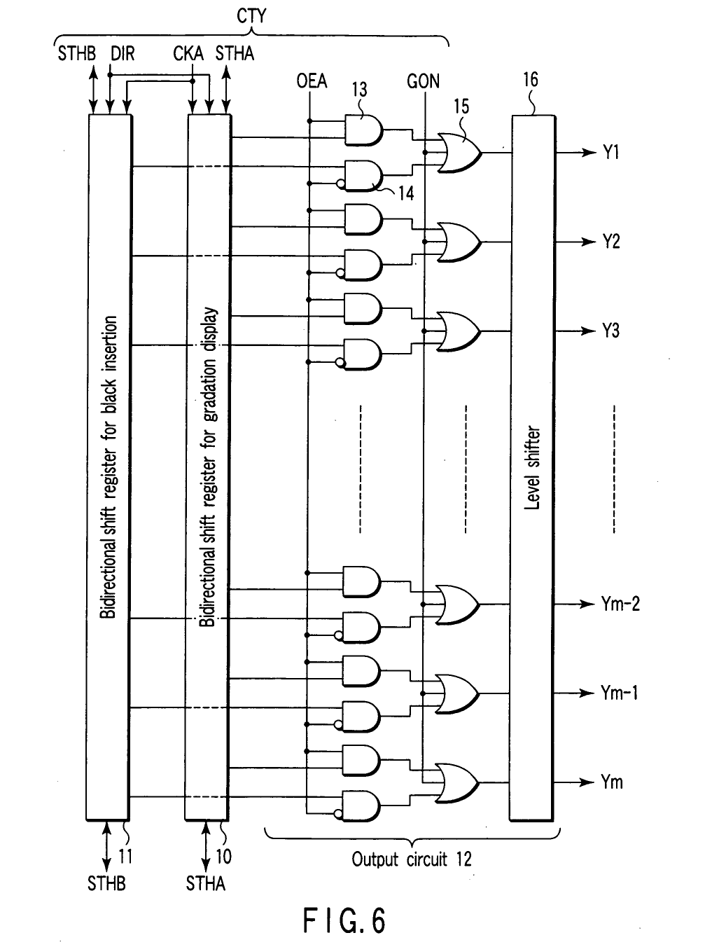

FIG. 6 shows a modification of the gate line driving circuit shown in FIG. 2. In this modification, the m-number of OR gate circuits 15 are configured to input an all-gate-line selection signal GON, which is supplied from the controller 5, to the level shifter 16 as the selection signals for the gate lines Y1 to Ym. Thereby, it becomes possible to drive all the gate lines Y1 to Ym at a time in the initializing process that is carried out upon supply of power, so as to apply pixel voltages Vs to all the pixel electrodes PE and transfer the splay alignment of the liquid crystal molecules to the bend alignment.

In addition, in this modification, the shift register 10 for gradation display and the shift register 11 for black insertion, which are shown in FIG. 2, are constructed as bidirectional shift registers that can shift the first start signal STHA and second start signal STHB in both directions, respectively. Specifically, the shift register 10 for gradation display and the shift register 11 for black insertion shift the first start signal STHA and second start signal STHB in a downward direction from the first-stage register toward the m-th stage register or in an upward direction from the m-th stage register toward the first-stage register. The directions of shift of the first start signal STHA and second start signal STHB are changed by a scan direction signal DIR that is supplied from the controller 5 to the shift register 10, 11. Normally, the viewing angle characteristics of the display panel DP are non-uniform in an up-and-down direction, that is, in a vertical direction. Thus, the ease in viewing deteriorates either in a case where the display panel DP is disposed above the viewer's point of view or in a case where the display panel DP is disposed below the viewer's point of view. For example, if the ease in viewing deteriorates when the display panel DP is disposed above the viewer's point of view, the ease in viewing can be improved by reversing the upper side and lower side of the display panel DP at this setting position and reversing the vertical scan direction.

As is understood from FIGS. 3 to 5, the second output enable signal OEB shown in FIG. 2 is an inverted signal of the first output enable signal OEA. In this modification, the m-number of AND gate circuits 14 are configured to receive inverted signals of the first output enable signal OEA, instead of the second output enable signal OEB. Thereby, the wiring for the output enable signals can be simplified.

In addition, as is understood from FIGS. 3 to 5, the second clock signal CKB shown in FIG. 2 has the same waveform as the first clock signal CKA. In this modification, the first clock signal CKA is input not only to the shift register 10 for gradation display, but also to the shift register 11 for black insertion, as the second clock signal CKB. Thereby, the wiring for clock signals can be simplified.

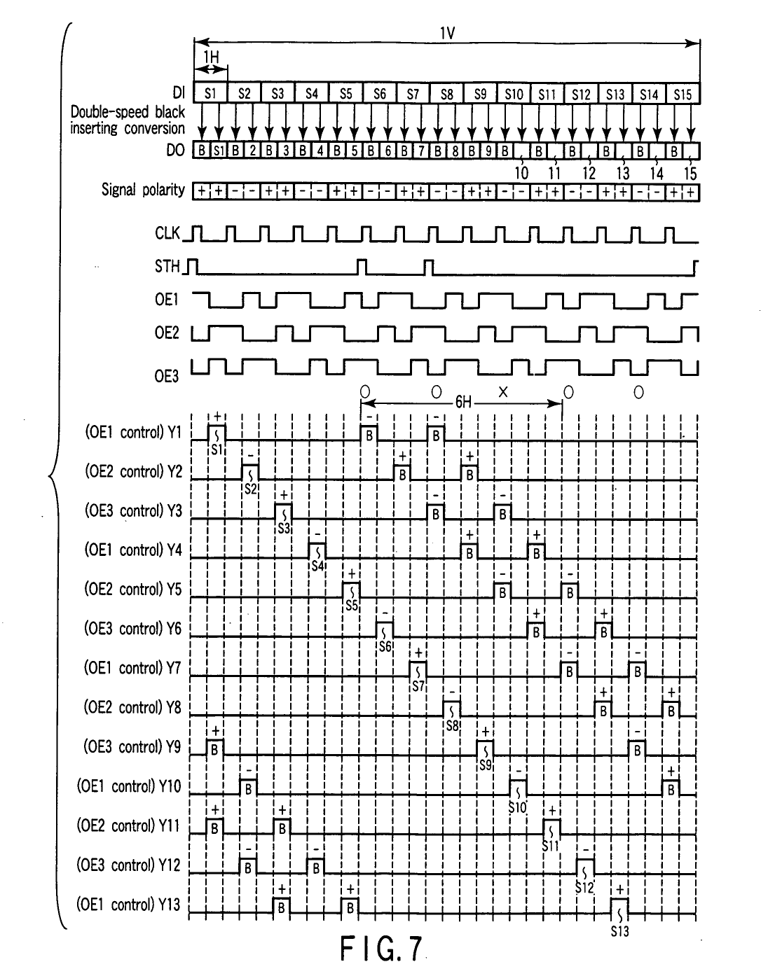

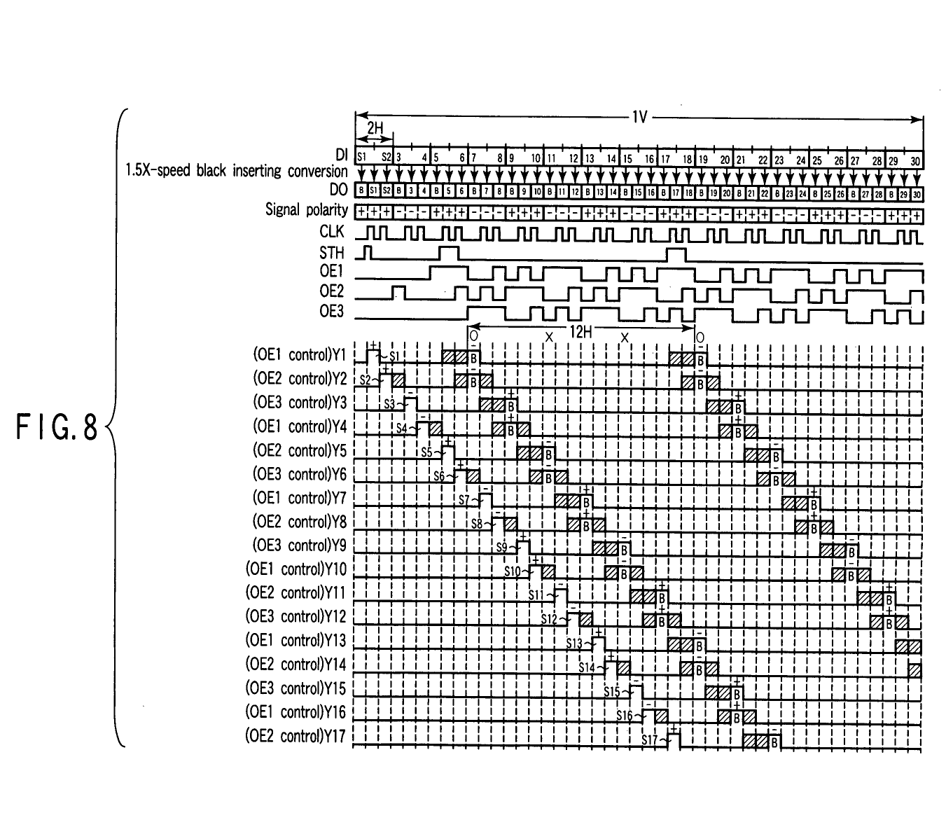

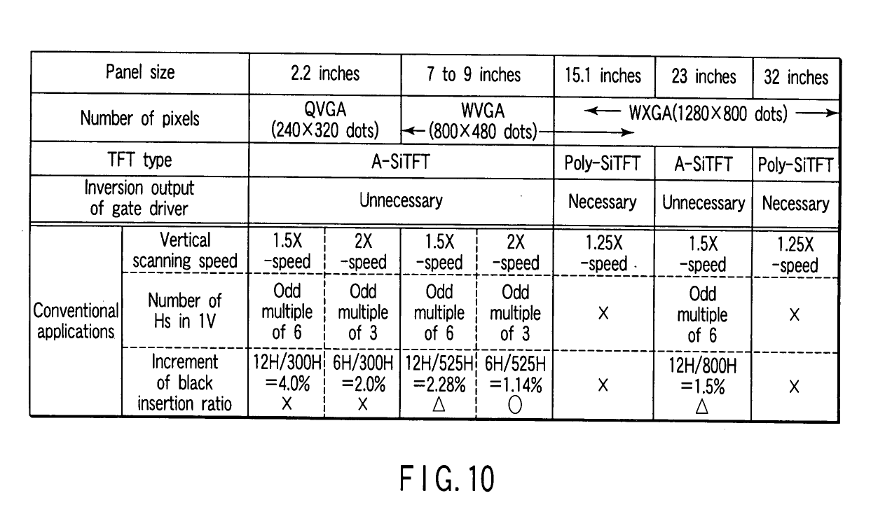

Referring now to FIG. 7 and FIG. 8, the gate line driving circuit according to the above-described embodiment is compared to a gate line driving circuit of a comparative example, each employing a single shift register and three output enable signals according to the prior art. FIG. 7 illustrates the operation of the gate line driving circuit of the comparative example in a case where black insertion driving is executed at 2× vertical scanning speed. FIG. 8 illustrates the operation of the gate line driving circuit of the comparative example in a case where black insertion driving is executed at 1.5× vertical scanning speed. In FIGS. 7 and 8, CLK, STH, OE1, OE2 and OE3 designate a clock signal, a start signal, and first to third output enable signals, which are input to the shift register. The source lines X1 to Xn are driven by the same scheme as in the example shown in FIG. 3 when the black insertion driving is executed at a 2× vertical scanning speed, and the source lines X1 to Xn are driven by the same scheme as in the example shown in FIG. 4 when the black insertion driving is executed at a 1.5× vertical scanning speed. Whether the vertical scanning speed is 2× or 1.5×, the shift register has to select the gate lines Y1 to Ym for gradation display and the gate lines Y1 to Ym for black insertion. The combination of the output enable signals OE1 to OE3 is used to adjust the black insertion timing and gradation display timing. As a result, as has been described with reference to FIG. 10, when the black insertion driving is executed at the 1.5× or 2× vertical scanning speed, a number of Hs, which is an odd multiple of 6 or an odd multiple of 3, which cannot be secured for small-sized VGA display panels, is required in 1V, and the increment of the black insertion ratio exceeds 2% that is a maximum practical value.

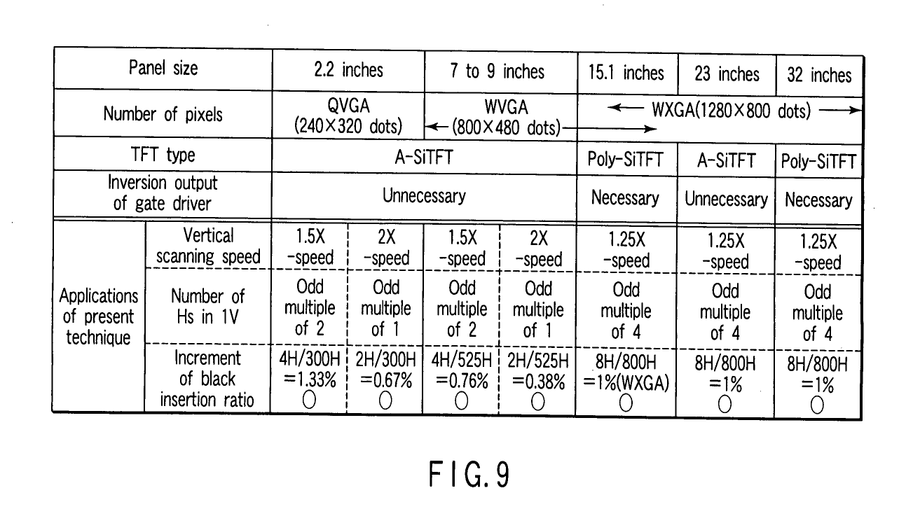

By contrast, when the technique of the present embodiment is applied, as shown in FIG. 9, black insertion driving can be executed at a 1.25× vertical scanning speed, which is preferable for large-sized WXGA display panels of 15.1 to 32 inches. The number of Hs in 1V is an odd multiple of 4, which can easily be secured for such display panels, and the increment of the black insertion ratio can be set at a practical value of 1%. At the 1.5× or 2× vertical scanning speed, which is preferable for medium-sized WVGA display panels of 7 to 9 inches and small-sized QVGA display panels of 2.2 inches, the numbers of Hs in 1V (vertical scanning period) are an odd multiple of 2 and an odd multiple of 1, which can easily be secured for such display panels. As regards the small-sized QVGA display panel, the increment of the black insertion ratio is 1.33% at the 1.5× vertical scanning speed, and 0.67% at the 2× vertical scanning speed. As regards the medium-sized WVGA display panel, the increment of the black insertion ratio is 0.76% at the 1.5× vertical scanning speed, and 0.38% at the 2× vertical scanning speed.

The present invention is not limited to the above-described embodiment, and various modifications can be made without departing from the spirit of the invention.

For example, the features of the modification shown in FIG. 6 may selectively be incorporated in the structure of the gate line driving circuit shown in FIG. 2.

Further, in the above-mentioned embodiment, the gate line driving circuit is used for black insertion driving. The structure of this gate line driving circuit can be used for any purpose other than the black insertion driving if the purpose requires a driving technique for cyclically applying a pixel voltage for non-gradation display to each pixel in addition to a pixel voltage for gradation display. In this case, the pixels are not restricted to OCB liquid crystal pixels. Thus, the gate line driving circuit is applicable not only to an OCB-mode liquid crystal display panel, but also to a flat display panel such as an EL (Electro Luminescence) display panel.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gate line driving circuit that drives a plurality of gate lines assigned to a plurality of pixels on a display panel, comprising:
a first shift register which shifts a first start signal in response to a first clock signal such that said gate lines are selected for gradation display in one vertical scanning period;
a second shift register which shifts a second start signal in response to a second clock signal synchronous with the first clock signal such that said gate lines are selected for non-gradation display in a period substantially equal to the vertical scanning period; and
an output circuit that outputs, under control of a first output enable signal, a driving signal to the gate line that is selected by said first shift register, and outputs, under control of a second output enable signal, a driving signal to the gate line that is selected by said second shift register.

2. The gate line driving circuit according to claim 1, wherein said output circuit includes:
a plurality of first AND gate circuits, each of which outputs, under control of the first output enable signal, a selection signal obtained from said first shift register for gradation display to the associated gate line;
a plurality of second AND gate circuits, each of which outputs, under control of the second output enable signal, a selection signal which is obtained from said second shift register to select the associated gate line for non-gradation display;
a plurality of OR gate circuits, each of which outputs the selection signal which is input from one of said first AND gate circuits to select the associated gate line for gradation display and the selection signal which is input from one of said second AND gate circuits to select the associated gate line for non-gradation display; and
a level shifter that converts the selection signal from each of said OR gate circuits to a driving signal by level-shifting.

3. The gate line driving circuit according to claim 2, wherein each of said OR gate circuits is configured to input an all-gate-line selection signal to said level shifter as the selection signal for the associated gate line.

4. The gate line driving circuit according to claim 1, wherein each of the first and second shift registers is a bidirectional shift register.

5. The gate line driving circuit according to claim 1, wherein said pixels are arrayed in a matrix, said gate lines are disposed along rows of pixels, and source lines are disposed along columns of pixels to supply pixel voltages for gradation display to the pixels corresponding to the gate line selected by said first shift register and pixel voltages for non-gradation display to the pixels corresponding to the gate line selected by said second shift register.

6. A gate line driving circuit that drives a plurality of gate lines, comprising:
a first shift register which shifts a first start signal in response to a first clock signal such that the gate lines are sequentially selected for gradation display;
a second shift register which shifts a second start signal in response to a second clock signal synchronous with the first clock signal such that the gate lines are sequentially selected for non-gradation display, in units of at least two lines; and
an output circuit that outputs, under control of a first output enable signal, a driving signal to the gate line that is selected by said first shift register, and outputs, under control of a second output enable signal, a driving signal to the gate line that is selected by said second shift register.
